(19) United States
(12) Patent Application Publication
(10) Pub. No.: US 2024/0102327 A1
(43) Pub. Date: Mar. 28, 2024

(54) Locks for Sliding Doors

(71) Applicant: Life Made Better, Intl. LLC, Bonham, TX (US)

(72) Inventors: Christopher Franck, Fort Mill, SC (US); Austin Lewis, Durham, NC (US)

(21) Appl. No.: 18/470,018

(22) Filed: Sep. 19, 2023

Related U.S. Application Data
(60) Provisional application No. 63/376,640, filed on Sep. 22, 2022.

(51) Int. Cl. E05C 19/00

(52) U.S. Cl. CPC E05C 19/003

(57) ABSTRACT

A lock for a sliding door includes: a central hub; a first leg extending from a first side of the central hub; a first foot at a terminal end of the first leg, the first foot configured to be attached to a frame of a door; a second leg extending from a second, opposite side of the central hub; and a second foot at a terminal end of the second leg, the second foot configured to be attached to a sliding panel of the door. The first and second legs may be configured to rotate between an extended position when the sliding panel is closed and a folded position when the sliding panel is open.

### RELATED APPLICATIONS

This application claims priority from U.S. Provisional Application Ser. No. 63/376,640, filed Sep. 22, 2022, the disclosure of which is hereby incorporated by reference in its entirety.

### BACKGROUND

There is a need for improved locks, including smart locks, for sliding barriers such as sliding glass doors.

### SUMMARY

Some embodiments of the present invention are directed to a lock for a sliding door. The lock includes: a central hub; a first leg extending from a first side of the central hub; a first foot at a terminal end of the first leg, the first foot configured to be attached to a frame of a door; a second leg extending from a second, opposite side of the central hub; and a second foot at a terminal end of the second leg, the second foot configured to be attached to a sliding panel of the door. The first and second legs may be configured to rotate between an extended position when the sliding panel is closed and a folded position when the sliding panel is open.

In some embodiments, the first and second legs are substantially horizontal in the extended position.

In some embodiments, the first and second legs are substantially vertical in the folded position.

In some embodiments, the lock further includes a lock mechanism in the central hub, the lock mechanism configured to lock the first and second legs in the extended position when the sliding panel is closed.

In some embodiments, the locking mechanism includes at least one pin operatively connected to a rotatable handle, and wherein the at least one pin is received in at least one aperture defined in the first leg and/or the second leg when the handle is rotated from an unlocked position to a locked position.

In some embodiments, the lock further includes a leg lift assist mechanism in the central hub, the leg lift assist mechanism configured to bias the first leg and/or the second leg toward the folded position when the first and second legs are in the extended position to thereby assist opening the sliding panel.

In some embodiments, the leg lift assist mechanism includes a spring configured to engage the first leg and/or the second leg.

In some embodiments, the lock further includes: a first bracket configured to be attached to the frame of the door and to receive the first foot; and/or a second bracket configured to be attached to the sliding panel and to receive the second foot.

In some embodiments, the lock is a smart lock.

Some other embodiments of the present invention are directed to a method including: positioning a lock in a door, the lock including a hub, a first leg and a second leg each extending from the hub, a first foot at a distal end of the first leg and attached to a frame of the door, and a second foot at a distal end of the second leg and attached to a sliding panel of the door; and moving the lock between a folded state and an extended state by opening and closing the sliding panel, respectively.

In some embodiments, moving the lock between the folded state and the extended state includes rotating the first leg about the first foot and the hub and rotating the second leg about the second foot and the hub.

In some embodiments, the method includes locking the lock in the extended state with a locking mechanism in the hub.

In some embodiments, the method includes biasing the lock toward the folded state using a leg lift assist mechanism in the hub that operatively engages the first and second legs.

### BRIEF DESCRIPTION OF THE DRAWINGS

FIG. 1 is a perspective view of a lock according to some embodiments of the present invention.

FIGS. 2A and 2B illustrate the lock of FIG. 1 installed in a sliding door. FIG. 2A illustrates the door closed and the lock in an extended position. FIG. 2B illustrates the door open and the lock in a folded position.

FIGS. 3A-3C illustrate a lock mechanism of the lock of FIG. 1. FIG. 3A illustrates the locking mechanism in an unlocked state (or unengaged). FIG. 3B illustrates the locking mechanism partially engaged. FIG. 3C illustrates the locking mechanism in a locked state (or fully engaged).

FIG. 4 illustrates a leg lift assist mechanism of the lock of FIG. 1.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are directed to a lock with a hub that moves with the door with legs that lock in place

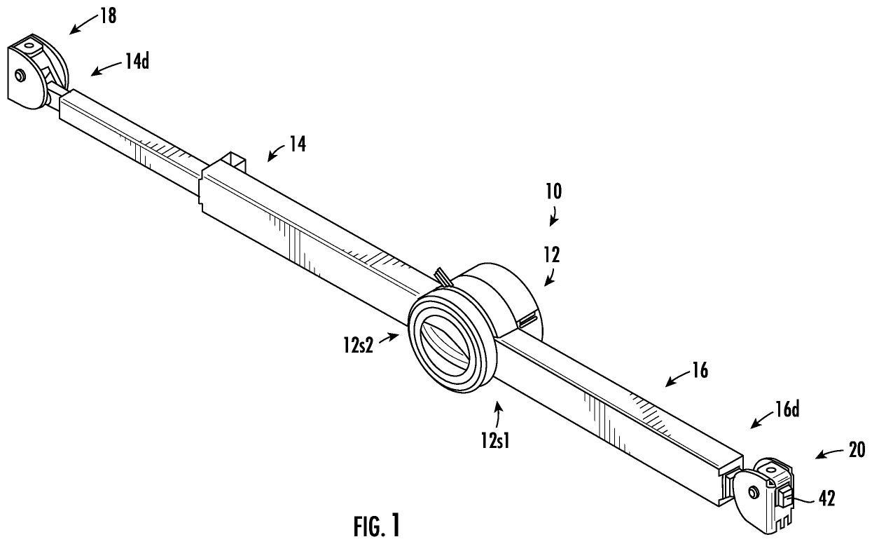

A lock 10 according to some embodiments is illustrated in FIG. 1. The lock 10 includes a central hub 12. A first leg 14 extends from a first side 12s1 of the central hub 12. A second leg 16 extends from a second, opposite side 12s2 (e.g., a diametrically opposed side) of the central hub 12. A first foot 18 is at a distal or terminal end 14d of the first leg 14 and a second foot 20 is at a distal or terminal end 16d of the second leg 16. The first leg 14 may be pivotally connected to the first foot 18 and the second leg 16 may be pivotally connected to the second foot 20.

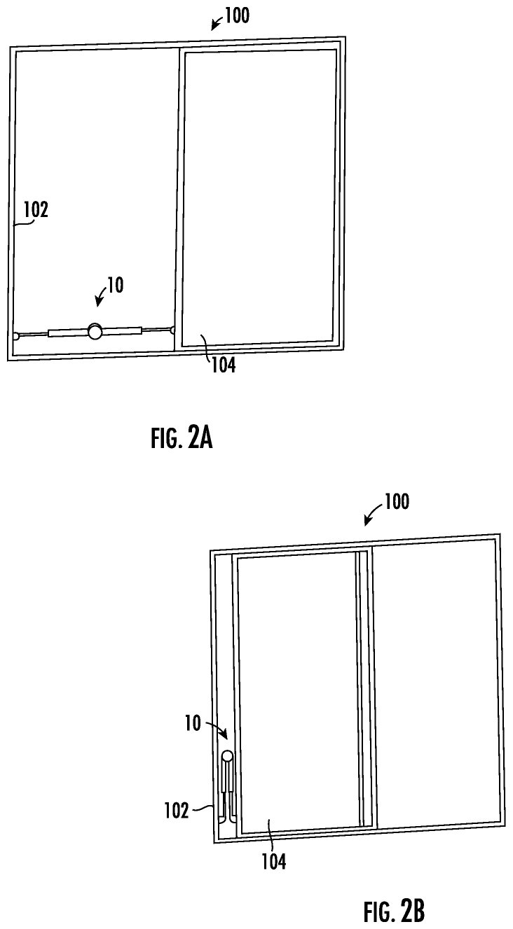

Referring to FIGS. 1, 2A, and 2B, the lock 10 is configured to be used with a sliding door 100 such as a sliding glass door. The first foot 18 is configured to be attached to a frame 102 of the door 100 and the second foot 20 is configured to be attached to a sliding panel 104 of the door 100. The first and second legs 14, 16 are pivotally coupled to the central hub 12. The first and second legs 14, 16 are configured to rotate between an extended position or state when the sliding panel is closed (FIG. 2A) and a folded position or state when the sliding panel is open (FIG. 2B).

The first and second legs 14, 16 may be substantially horizontal in the extended position. The first and second legs 14, 16 may be substantially vertical in the folded position. As used herein, the terms “substantially horizontal” and “substantially vertical” may mean that the legs are within 10° or 20° of horizontal or vertical in various embodiments.

Referring again to FIG. 1, the first leg 14 and/or the second leg 16 may have an adjustable length such that the lock 10 can be used in doors of varying dimensions. In some embodiments, a length of the lock 10 (i.e., in the extended position) may range from 25″ to 36″ to be used on sliding doors that are 5 to 6 feet wide. In some embodiments, the length of the lock could be increased for larger doors (e.g., those up to 8 feet wide).

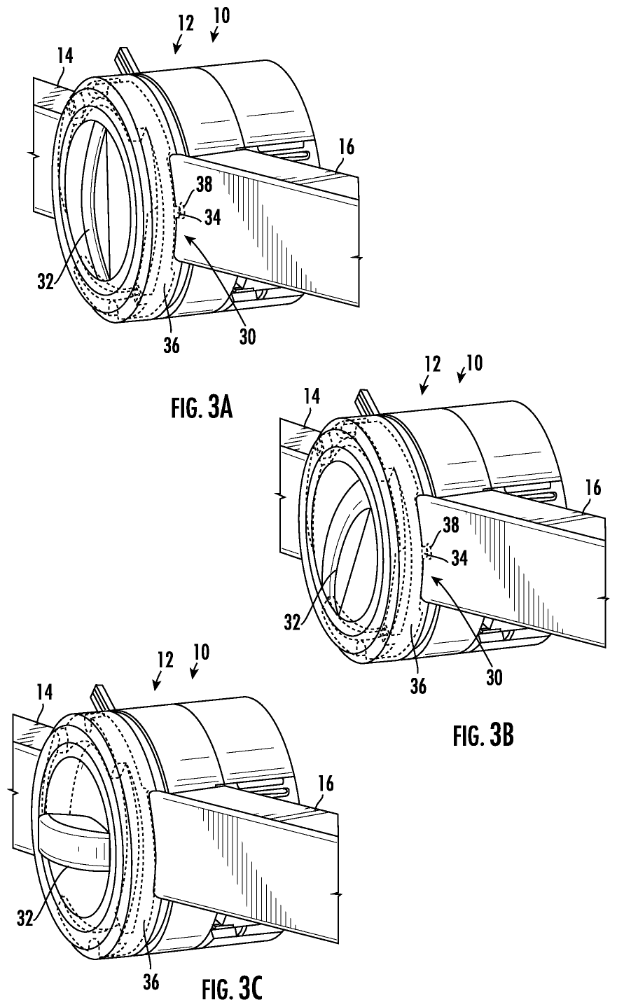

Referring to FIGS. 3A-3C, the lock 10 may include a lock mechanism 30 in the central hub 12. The lock mechanism 30 may include a handle 32 and at least one pin 34 operatively connected to the handle 32. The pin(s) 34 may be on a carriage 36 that is connected to the handle 32. As illustrated in FIGS. 3A-3C, as the handle 32 rotates, the pin(s) 34 advance into aperture(s) or hole(s) 38 defined in the first leg 14 and/or the second leg 16. In some embodiments, the lock mechanism includes first and second pins 34 with the first pin 34 advancing into a first aperture 38 in the first leg 14 and the second pin 34 advancing into a second aperture 38 in the second leg 16 responsive to rotation of the handle 32.

With the lock mechanism fully engaged as shown in FIG. 3C (i.e., locked position), the first and second legs 14, 16 cannot rotate. Thus, the lock mechanism 30 is configured to lock the first and second legs 14, 16 in the extended position when the sliding panel is closed (FIG. 2A). This also reinforces the door and ensures that the sliding panel of the door cannot be forced open. When the lock mechanism 30 on the hub 12 is in the unlocked position the hub 12 and legs 14, 16 are free to fold and unfold as the sliding panel of the door opens and closes.

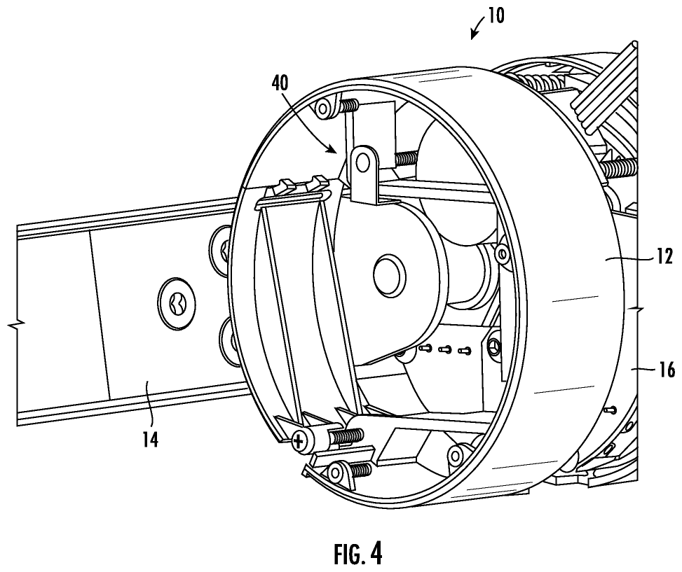

Referring to FIG. 4, the lock 10 may include a leg lift assist mechanism 40 such as a spring that biases the first leg 14 and/or the second leg 16 toward the folded position when the first and second legs 14, 16 are in the extended position to thereby assist opening the sliding panel. The spring 40 exerts pressure on the first leg 14 and/or the second leg 16 in the extended position to ensure they are biased to returning to the folded position as the door slides.

The lock 10 or a kit associated with the lock 10 may include brackets for attachment of the lock to the door. A first bracket may be attached to the door frame and a second bracket may be attached to the sliding panel of the door (e.g., using high strength double sided tape such as VHB tape). Referring to FIG. 1, the feet 18, 20 may include a hook or tab 42 that is configured to be received in a corresponding groove in the first and second brackets to thereby install the lock 10 in the door.

The lock 10 may be a smart lock. For example, the lock 10 may controlled by a mobile application (or app) stored on a user's mobile device such as a smartphone.

Sliding glass doors are known as a target for people trying to gain entry into a home due to their relatively weak locking mechanisms. The lock described herein provides a robust solution for securing sliding glass doors and optionally provides a smart lock solution for sliding glass doors for even greater security.

Although the lock has been described for use with sliding glass doors, it may also be advantageously used for other sliding barriers such as windows, barn doors, etc. It will be appreciated that the dimensions of the lock may differ for these varying applications (e.g., the lock may be adjustable to be “shorter” in the extended position for window applications).

Although the lock has been described as including a hub and two opposing legs, it is also contemplated that the lock could include a hub and a single leg. For example, for a sliding door application, the hub could be connected to the door frame and the distal end of the single leg could be connected to the sliding panel.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

We claim:

1. A lock for a sliding door, the lock comprising:
a central hub;
a first leg extending from a first side of the central hub;
a first foot at a terminal end of the first leg, the first foot configured to be attached to a frame of a door;
a second leg extending from a second, opposite side of the central hub; and
a second foot at a terminal end of the second leg, the second foot configured to be attached to a sliding panel of the door,
wherein the first and second legs are configured to rotate between an extended position when the sliding panel is closed and a folded position when the sliding panel is open.

2. The lock of claim 1 wherein the first and second legs are substantially horizontal in the extended position.

3. The lock of claim 2 wherein the first and second legs are substantially vertical in the folded position.

4. The lock of claim 1 further comprising a lock mechanism in the central hub, the lock mechanism configured to lock the first and second legs in the extended position when the sliding panel is closed.

5. The lock of claim 4 wherein the locking mechanism comprises at least one pin operatively connected to a rotatable handle, and wherein the at least one pin is received in at least one aperture defined in the first leg and/or the second leg when the handle is rotated from an unlocked position to a locked position.

6. The lock of claim 1 further comprising a leg lift assist mechanism in the central hub, the leg lift assist mechanism configured to bias the first leg and/or the second leg toward the folded position when the first and second legs are in the extended position to thereby assist opening the sliding panel.

7. The lock of claim 6 wherein the leg lift assist mechanism comprises a spring configured to engage the first leg and/or the second leg.

8. The lock of claim 1 further comprising:
a first bracket configured to be attached to the frame of the door and to receive the first foot; and
a second bracket configured to be attached to the sliding panel and to receive the second foot.

9. The lock of claim 1 wherein the lock is a smart lock.

10. A method comprising:
positioning a lock in a door, the lock comprising a hub, a first leg and a second leg each extending from the hub, a first foot at a distal end of the first leg and attached to a frame of the door, and a second foot at a distal end of the second leg and attached to a sliding panel of the door; and
moving the lock between a folded state and an extended state by opening and closing the sliding panel, respectively.

11. The method of claim 10 wherein moving the lock between the folded state and the extended state comprises rotating the first leg about the first foot and the hub and rotating the second leg about the second foot and the hub.

12. The method of claim 10 further comprising locking the lock in the extended state with a locking mechanism in the hub.

13. The method of claim 10 further comprising biasing the lock toward the folded state using a leg lift assist mechanism in the hub that operatively engages the first and second legs.
